(19) United States
(12) Patent Application Publication
(10) Pub. No.: US 2024/0377320 A1
(43) Pub. Date: Nov. 14, 2024

(54) MEASURING DEVICE AND METHOD FOR MEASURING A GEOMETRIC PARAMETER OF AN OBJECT

(71) Applicant: Sikora AG, Bremen (DE)

(72) Inventors: Christian Frank, Bremen (DE); Kolja Tobias Schuh, Bremen (DE); Harald Sikora, Bremen (DE)

(73) Assignee: Sikora AG, Bremen (DE)

(21) Appl. No.: 18/659,184

(22) Filed: May 9, 2024

(30) Foreign Application Priority Data
May 11, 2023 (EP) 23 172 870.0

(51) Int. Cl. G01N 21/3581; G01B 11/06; G01B 11/12; G01N 21/3563

(52) U.S. Cl. CPC G01N 21/3581; G01B 11/06; G01B 11/12; G01N 21/3563

(57) ABSTRACT

A measuring device for measuring a geometric parameter of an object includes a transceiver including a transmission apparatus structured to emit terahertz radiation onto the object. The terahertz radiation is at least partially reflected by the object. A receiving apparatus is structured to receive the terahertz radiation emitted by the transmission apparatus onto the object. A reflector is structured to reflect the terahertz radiation emitted by the transmission apparatus after the terahertz radiation has passed through at least one portion of the object. A holder is structured to support the transceiver and the reflector, and to position the transceiver and the reflector opposite one another on different sides of the object or on different sides of a wall of the object.

### CROSS REFERENCE TO RELATED INVENTION

This application is based upon and claims priority to, under relevant sections of 35 U.S.C. § 119, European Patent Application No. 23 172 870.0, filed May 11, 2023, the entire contents of which are hereby incorporated by reference.

### BACKGROUND

The following disclosure relates to a measuring device for measuring a geometric parameter, in particular an inner and/or outer diameter and/or a wall thickness, of a flat or strand-shaped, in particular tubular, object, comprising a transceiver having a transmission apparatus for emitting terahertz radiation onto the object, wherein the terahertz radiation is at least partially reflected by the object, and having a receiving apparatus for receiving the terahertz radiation emitted by the transmission apparatus onto the object, wherein the measuring device is a measuring device that is portable for an operator.

The following disclosure further relates to a method for measuring a geometric parameter, in particular an inner and/or outer diameter and/or a wall thickness of a flat or strand-shaped, in particular tubular, object.

In the manufacture of plastics pipes in extrusion lines, for example, it is desirable to be able to measure geometric parameters, for example wall thicknesses and inner or outer diameters in a flexible manner, at an early stage, and at various locations on the production line. For this purpose, terahertz measuring devices are known from the prior art which emit terahertz radiation onto the object and receive terahertz radiation reflected by the object. For example, geometric parameters such as wall thicknesses or diameters can be determined based on delay time measurements.

For fast and flexible measurement of geometric parameters at different locations on a production line, hand-held devices that can be carried by an operator are helpful. A portable device is known from DE 10 2016 119 728 A1. It comprises a support contour having multiple contact points for positioning the device on the object to be measured. The known portable device can be used, for example, to determine the geometric wall thickness if the refractive index of the material of the object is assumed to be known.

For frequently used plastics materials, such as PE, PP, HDPE, PVDF, PTFE, PVC, etc., in pure form, reliable refractive index values are known for standard conditions. In principle, the refractive index depends on the temperature of the material, on the state of aggregation thereof, and thus on the density thereof, but also on the frequency used. However, in practice, additives are often added to the plastics materials, for example for better protection against UV radiation or to achieve anti-static properties. Additives alter the refractive index and the addition of additives is often subject to fluctuations on account of irregular admixtures or fluctuating proportions of the additives in the supplied plastics materials. The requirements for measuring geometric parameters of pipes of this kind are established in the standard DIN EN ISO 3126. The required level of measuring accuracy is demanding. A change in the refractive index due to added additives can significantly distort a wall thickness measurement with the known portable device if the refractive index is assumed to be constant. Therefore, for reliable measured values for the wall thickness of a plastics material, it is urgently advised to detect the refractive index directly at the measurement location for a wall thickness in order to use same in the calculation of the geometric wall thickness.

In order to determine the refractive index or rather to calibrate a first terahertz measuring apparatus with regard to the refractive index, DE 10 2022 100 650 B3 proposes performing a wall thickness measurement on an already cooled pipe piece using a mechanical tactile measuring apparatus, by means of which a second terahertz measuring device that measures the cooled pipe piece is calibrated. This can in turn be used to calibrate the first terahertz measuring apparatus. In this way, the individual refractive index of the object to be measured can be determined at the measurement location and accurate geometric parameters can thus be determined. However, the calibration procedure is very time-consuming due to the delay time between the first measurement and the final measurements on the cooled pipe being one or more hours. Finally, this method merely provides a value for the refractive index at the first measurement location, i.e. in the so-called hot zone, in which the plastics material has only partially solidified. Aside from the proportion of additives in the plastics material, the temperature thereof, the density, and the state of aggregation of the material also have an influence on the refractive index value.

Proceeding from the explained prior art, the object of the invention is to provide a measuring device and a method of the type mentioned at the outset, by means of which geometric parameters can be determined in a flexible and reliable manner at different locations on the object.

### BRIEF SUMMARY OF THE INVENTION

An embodiment of a device for measuring a geometric parameter of an object comprises a holder that supports the transceiver as well as a reflector for reflecting the terahertz radiation emitted by the transmission apparatus after said terahertz radiation has passed through at least one portion of the object. The holder is structured such that the measuring device for measuring the geometric parameter of the object can be placed against the object such that the transceiver and the reflector are opposite one another on different sides of the object or a wall of the object.

The object to be measured may, for example, be cylindrical or tubular. It may also be a flat or rather planar object. It is at least partially transparent to the terahertz radiation emitted by the transmission apparatus, such that terahertz radiation emitted onto the object is reflected on boundary surfaces of the object. Some of the terahertz radiation can pass through the object and, after being reflected on the reflector, return to the receiving apparatus, where said radiation and the radiation components reflected by the object are received as measurement signals. The transmission apparatus and the receiving apparatus are designed to be integrated into a transceiver and are, in particular, located at the same location. The object may comprise a plastics material, for example PE, PP, HDPE, PTFE, PVDF, or PVC. However, the object may also comprise, for example, of glass or ceramic material or frozen water or wood or construction materials of various types, provided that it is at least partially transparent to the terahertz radiation used. The terahertz radiation may, for example, emit radiation in a frequency range of from 1 GHz to 6 THz, in particular in a frequency range of from 10 GHz to 1.5 THz. The object may be conveyed in a longitudinal direction through a measuring region of the measuring device. For example, the object may have been manufactured in an extrusion device and, for example, be measured by means of the measuring device according to the invention or, alternatively, method according to the invention while still in the extrusion line. The object may still comprise flowable components, i.e. not be completely cooled or rather solidified, at the time of the measurement with the measuring device according to the invention or, alternatively, method according to the invention. This applies, in particular, to a measurement shortly after exit from the extrusion device or a first cooling tank of the extrusion line. The transmission apparatus may emit FMCW terahertz radiation, in particular broadband terahertz radiation.

As already explained, the receiving apparatus receives the terahertz radiation emitted by the transmission apparatus and at least partially reflected by the object. As already explained as well, the receiving apparatus may also receive terahertz radiation that has passed through the object. The measuring device according to the invention is portable for an operator, in particular during the measurement. It is therefore a hand-held device. The measuring device preferably has its own energy supply for electrical energy, in particular a battery, preferably a rechargeable battery. As is known per se, the receiving apparatus may, for example, determine geometric parameters of the object, for example a wall thickness and/or an inner and/or outer diameter, based on delay time measurements of the terahertz radiation reflected at different boundary layers of the object and display the results on a display. For this purpose, the measuring device may comprise a corresponding evaluation apparatus, as will be explained in more detail below.

According to an embodiment, the measuring device comprises a holder which supports the transceiver as well as a reflector for reflecting the terahertz radiation emitted by the transmission apparatus after said radiation has passed through at least one portion of the object. The holder is structured such that the measuring device can be placed against an object for a measurement process in such a way that the transceiver and the reflector are opposite one another on different sides of the object or on different sides of a wall of the object. Terahertz radiation emitted by the transmission apparatus is thus reflected by the reflector after having passed through the object or the wall of the object, such that, after passing through the object or the wall of the object again, the terahertz radiation returns to the transceiver, in particular the receiving apparatus, where said radiation is detected as a measurement signal. As will be explained in more detail below, it is thus possible to determine the individual refractive index of the material of the object just measured at the same location and thus also to determine reliable and precise measured values of the relevant geometric parameter in the event of a changing composition of the object or even in the event of a composition that is not known with sufficient accuracy, for example due to the addition of additives. At the same time, due to the configuration of the portable measuring device with the holder, a measurement can be performed by an operator at largely arbitrary locations on the object or rather on a production line for the object. The measurement results are reliable and available quickly. Although measuring devices arranged in a stationary manner can potentially deliver measurement results continuously, the portable measuring device according to the invention can achieve a reliable measurement result in a very flexible manner. On account of the configuration according to the invention with the holder as well as the transceiver and reflector, the refractive index and measurement results of the geometric parameter based thereon can be obtained in one measuring step. Reliable documentation for acceptance of the object within the context of a production line is thus also possible.

In contrast to the hand-held device of the prior art explained at the outset, the measuring device according to the invention does not rely on presuming the refractive index of the object to be known. Rather, the precise value of the refractive index of the object is recorded directly at the measurement location itself and included in the calculation of the measured values for the geometric parameter. As a result, the requirements imposed by the standard DIN EN ISO 3126 are fully met.

Provided that the transceiver and the reflector are opposite one another on different sides of a wall of the object in the state placed against the object, the measuring device can, for example, be placed at the end of a tubular object, for example subsequently to production, i.e. immediately before and also after the tubular object is cut to length. The reflector or the transceiver is then arranged inside the tubular object, while the other of the two is arranged opposite on the outer face of the tubular object. According to the invention, in addition to wall thicknesses and diameters, ovalities of a tubular object, for example, can also be reliably determined as geometric parameters during production or subsequently to production by measuring, for example, the inner or outer diameter multiple times over the circumference of the object. For this purpose, the measuring device can be rotated as a whole or, for example, only the transceiver can be rotated about a longitudinal axis, for example, of a tubular object while the reflector remains still. For the rotation, the measuring device may comprise a rotary drive. By measuring around the circumference of the object, in addition to wall thickness fluctuations, it is possible, for example, to identify inhomogeneities in the material of the object, for example an inhomogeneous distribution of additives around the circumference of the object. The measuring device could also detect an absorption of the terahertz radiation caused by the object, for example by comparing the terahertz radiation emitted and then recovered after being reflected on the reflector. In this way, the portable measuring device is also well suited for checking whether the object or rather a material of the object can be measured in the manner according to the invention and, if applicable, to what thickness.

In principle, the portable device should be suitable for measuring small and large objects and, if applicable, also at short distances from the surface of the object. The antenna of the transceiver should thus have a high gain of preferably 20 to 30 dBi and a sensitivity that is sufficient with the accompanying amplitudes. In order to prevent overmodulation of the reception signal, closed-loop control of the transmission power that allows for adaptation to the relevant situation of the reception signals can be useful. Sufficiently fast control is useful, for example, in order to be able to perform a measuring process at a different transmission power, adapted to a front and rear wall thickness of a pipe, for example.

According to a particularly practical embodiment, the holder may be C-shaped. The transceiver and the reflector may then be arranged at the opposite free ends of the C-shaped holder. A C-shaped holder of this kind may, for example, consist of plastics material, for example a carbon fiber-reinforced plastics material. Provided that a C-shaped or curved holder of the measuring device is sufficiently large, the transceiver and the reflector can, for example, be positioned on opposing outer faces of the object during measurement of a tubular object.

The holder may form a stop which can be placed against an end face of the object for placement of the measuring device. In this way, a defined position of the measuring device relative to the object, in particular an end face of a flat object or a pipe that has already been cut to length, is made available. For example, when measuring the wall thickness of pipes, a particular distance from the cut edge of the pipe, for example at least 50 mm, is often prescribed. Due to the stresses released in the material, there are often no reliable values for the wall thickness at the cut edges themselves. The prescribed distance from the cut edge can be ensured at all times with the above-mentioned design. This also applies, for example, to a measurement of the wall thickness over the circumference of the pipe.

According to a further embodiment, in order to allow for adjustability of the distance from an edge, for example a cut edge, of the object in order to adapt to different requirements or conditions, it can be provided that the transceiver and/or the reflector is mounted on the holder in a longitudinally displaceable manner, in particular in the longitudinal direction of the object in the state placed against the object.

According to a further embodiment, the transceiver and/or the reflector may be detachably arranged on the holder. In this way, a measurement with the measuring device is possible with or without the reflector as needed. A measurement without a reflector is useful, for example, if the refractive index of the material of the object is known to a sufficiently reliable extent even without a corresponding measurement. A combination of the measuring device with a reflector arranged, for example, in a stationary manner on a production line of the object, for example an extrusion line of a tubular object, is then possible as well. A stationary reflector of this kind could, for example, be arranged at the start of an extrusion line for the object, for example at the outlet of a first cooling tank in which the object undergoes a first cooling after exiting the extrusion device. If, for example, the reflector arranged in a stationary manner also has a receiving portion for the transceiver of the measuring device or the holder of the measuring device, a precise orientation would thus be ensured at all times for the measurement. Particularly simple mounting of a reflector in combination with a holder for a transceiver, for example directly at the outlet of a first cooling tank or, alternatively, upstream of the inlet into a further cooling tank or, alternatively, between further cooling tanks of the production line can thus be achieved and ensures a high degree of repeatability for the measurement path between the transceiver and the reflector. Therefore, an accurate measurement in the warm zone of the production line is possible, i.e. when the object thus still has flowable components and is thus still subject to a certain amount of shrinkage and sagging. Although measurement results that may deviate from the final geometric parameters of the fully solidified object are obtained in this warm zone, they can be an important aid when setting up the production line, in particular when pre-setting an extrusion device with regard to the wall thickness and the expected sagging. It is currently common practice to mechanically measure the outer dimension of the diameter of a tubular object in the warm zone using a tape measure. Here, the invention allows for simple non-contact detection using the measuring device. With knowledge of the outer diameter, for example, of a tubular object and with the measurement of the inner diameter by means of the measuring device according to the invention, the double wall thickness of the tubular object can be ascertained and individual geometric wall thickness values can be determined from the detected optical wall thickness values both at the front and at the rear. Detachment of the transceiver from the holder may also be useful, for example in order to recharge a battery of the transceiver or to change to another transceiver or the like. Even a folding design of the reflector, for example, is conceivable such that the reflector can be used while still held on the holder and either folded into the measurement path or folded out thereof.

A detachable design of the transceiver on the holder also has the advantage that the transceiver can be combined with different holders, depending on the intended use. Accordingly, the measuring device may also comprise multiple holders that are designed in the manner according to the invention and that are optimized for different purposes. The detachable arrangement of the reflector on the holder also allows for simple yet precise and user-friendly locking of the reflector. In order to precisely determine the geometric dimensions, the wall thickness, the wall thickness and/or diameter values, exact determination of the refractive index is important, namely the detection of the delay time differences between direct irradiation of the reflector and irradiation thereof after radiation has passed through materials, which increases the delay time. This means that no changes in distance in the range of a few micrometers can take place between calibration of the distance of the reflector and practical use thereof. In the case of a refractive index of typically 1.5 for plastics materials and approximately 2 for glass, this means that approximately one third of any change in distance of the reflector is included in the wall thickness value in the case of plastics materials, and one half in the case of glass. Thus, a precise arrangement of the transceiver and reflector is particularly important.

According to a further embodiment, the reflector may be spaced apart from a wall of the object that is adjacent to the reflector and through which the terahertz radiation passes in the state of the measuring device placed against the object. There is therefore a certain distance between the reflector and the portion of the object to be measured, for example the wall of the object. In this way, echoes of the reflector and of the spaced-apart surface, for example an inner wall of a tubular object, can be reliably separated in the measurement signal.

The holder may further comprise at least one support by means of which the transceiver and/or the reflector rests on a surface of the object in the state placed against the object. On account of a support of this kind, a defined arrangement or rather position of the transceiver and/or reflector in relation to the object to be measured is ensured. The at least one receiving portion may, for example, comprise at least one guide runner or rather skid. It is also possible, for example, for the at least one support to comprise at least one guide roller that rests on the surface of the object in the state placed against the object. The at least one support may be adjustable in order to adapt to different dimensions of the object. For example, the at least one support may comprise at least two support portions that are spaced apart from one another and that can be pressed apart counter to a preload. The preload may, for example, be provided by means of a preload spring. The at least one support can be adapted to different dimensions of the object manually. However, an electric drive, for example, is also conceivable. Instead of a preload by means of a preload spring, another design, for example, is also conceivable, for example a resilient toothed belt with outward-facing teeth. A particularly practical design in this regard may, for example, comprise two support portions that can be adapted in order to adapt to different dimensions of the object and that, for example, can be placed on an outer face of the object as well as comprise a support portion arranged on the opposite side for abutting an inner face of the object.

At least one sensor may also be provided, by means of which the measuring device with the holder can be oriented for a measurement process without contacting the object. The at least one sensor may, for example, comprise at least one optical sensor and/or at least one inertial sensor and/or at least one position sensor. In this case, the measuring device may also be oriented without mechanical guidance, for example using optical orientation with three or four distance sensors, for example time-of-flight sensors. For the measurement itself, the distance, for example from the transceiver to the surface of the object, is of little importance. However, an orientation that is as vertical as possible, i.e. 90° to the measuring plane, is important. The orientation with optical sensors may, for example, take place in that a symbol, for example a reticle, is displayed on a display or the like with manual triggering of the measurement or with automatic recognition and automated triggering of the measurement when, for example, a vertical orientation is achieved. Orientation using gyroscopic sensors or using the transceiver itself would also be conceivable. It is also possible for the transmission apparatus to transmit as early as during the orientation procedure and to use the corresponding measured values received by the receiving apparatus when an optimal orientation is detected, for example by means of corresponding inertial or position sensors. When using position sensors, it is also possible, for example, to assign the measured values to different positions on the circumference of a tubular object.

According to a further embodiment, the reflector may have the shape of a cylindrical portion. This can simplify guidance of the measuring device, in particular if the cylindrical shape is adapted to the geometry of a tubular object, in particular a curvature aligned with the center axis of a tubular object. In particular in conjunction with the detachable arrangement of the reflector on the holder, differently shaped reflectors, for example reflectors with different cylinder radii, can be used, in particular in order to adapt to differently sized objects. In this way, geometric parameters of very small pipes, for example, can also be measured reliably.

Depending on the use of the measuring device, the reflector can be used, for example, to measure the wall thickness at the edge of an object or merely to detect the refractive index of the material for further measurements of the same object. According to a further embodiment, the reflector may be partially transparent to the terahertz radiation emitted by the transmission apparatus. In this case, some of the terahertz radiation emitted by the transmission apparatus is reflected by the reflector, while some passes through the reflector. A 100% reflective reflector is known in optics as an integrating sphere. For optimal reflection of the transmitted high frequency, said reflector should be shaped such that its center point is located in the region of the transmission/reception antenna of the transceiver. This also applies to the reflector according to the invention. Alignment of the curvature of the reflector with the center point, for example, of a pipe would only be optimal if the antenna of the transceiver were also aligned with the center point of the pipe. A partially reflective reflector may be useful, in particular, if a wall of the object located between the transceiver and the reflector as well as a wall arranged on a side of the reflector facing away from the transceiver are to be measured in the case of an arrangement of the reflector inside a tubular object. Using a partially transparent reflector makes it possible to measure the refractive index of the material of the object and also the wall thickness of both wall portions of the tubular object and, at the same time, the outer and inner diameter. A two-part design of the reflector with two reflector portions arranged symmetrically with respect to one another would also be conceivable.

A narrow configuration of the reflector is also possible, such that some of the terahertz radiation emitted by the transmission apparatus strikes the reflector and is reflected thereby, and some of the terahertz radiation passes by the reflector. In this case, it is also possible to determine the refractive index and to measure the wall thickness and the inner and outer diameter in the case of a reflector that reflects all of the terahertz radiation. It is particularly advantageous to configure the reflector such that it has a correspondingly narrow contour, such that enough signal can make it back from the reflector to the transceiver in spite of the wall thickness to travel through and such that a sufficient amount of the radiation can pass through in order to examine the second wall thickness of a pipe and thus to determine both wall thicknesses, as well as the inner and outer diameter of a pipe. For a hand-held measuring device, it is of practical importance if a device is small and handy and also has small dimensions. This can be achieved with a correspondingly narrow reflector.

According to a further embodiment, the holder may be flexible. For example, if it is configured to be curved, it can thus be adapted to different sizes of the object. Possible materials for the holder are, in principle, plastics materials or metals. Even glass fiber-reinforced or carbon fiber-reinforced plastics materials could be used. Flexible holders may comprise, in particular, of plastics material.

The measuring device may further comprise a holding portion which can be arranged or, alternatively, is arranged in a stationary manner on a manufacturing apparatus for manufacturing the object and to which the transceiver and/or the holder can be fastened or, alternatively, is fastened in a detachable manner. For example, the holding portion may comprise a base plate which may rest on the floor of a production area that houses the manufacturing apparatus. The base plate may be fastenable to the floor, for example via a screw connection or the like. The holding portion may form a stand and ensures positionally precise arrangement and, if applicable, guidance of the measuring device around the circumference of the object to be measured. In this way, for example, the wall thickness can be detected in a particularly precise manner via the circumference and/or an outer and/or inner diameter and/or an ovality of a, for example, tubular object. The manufacturing apparatus may comprise an extrusion device in which the object is manufactured by means of extrusion.

The measuring device according to the invention may further comprise an evaluation apparatus which is designed to determine a geometric parameter, in particular a wall thickness and/or an inner and/or outer diameter, of the object based on measured values received by the receiving apparatus. As explained at the outset, the corresponding geometric parameters may be determined, for example, based on delay time measurements. The evaluation apparatus may be integrated in the transceiver or it may be separate therefrom. The transceiver may also comprise a display apparatus for the recorded measured values and the detected refractive index. As a result, an operator may read off the corresponding values quickly and easily. If the evaluation apparatus is separate from the transceiver, it may, for example, comprise a charging station for the transceiver. The transceiver may also be equipped with a network or Internet interface, for example a LAN interface. It is also possible for the transceiver to be operated autonomously with a Power-over-Ethernet (POE) connection. It is also possible for the holder to be equipped with a LAN connection to a separately arranged evaluation apparatus or to a further measuring device, and/or with a voltage supply for the transceiver, for example in combination with a charging device for a battery of the measuring device. As already explained, the voltage supply may take place via a combined Power-over-Ethernet connection. For example, the transceiver may transmit its measurement data to a central evaluation unit or to another measuring apparatus that is, for example, arranged in a stationary manner on an extrusion line. This may, for example, be a measuring apparatus which is arranged in the warm zone of the extrusion line, i.e. at a short distance from the extruder. As explained, in this warm zone the object has regions that have not yet solidified.

The evaluation apparatus may further be configured to determine the refractive index of the object from a comparison of the delay time of the terahertz radiation emitted by the transmission apparatus and received by the receiving apparatus with said radiation passing through the object with the delay time of the terahertz radiation emitted by the transmission apparatus and received by the receiving apparatus without said radiation passing through the object. Such determination of the refractive index is explained, for example, in WO 2016/139155 A1 and can be used in the present case.

The measuring device may further comprise a wireless transmission apparatus for transmitting measured values received by the receiving apparatus to an evaluation apparatus that is separate from the measuring device and/or for transmitting data evaluated by an evaluation apparatus integrated in the measuring device to a control apparatus that is separate from the measuring device. The measuring device may, for example, be equipped with WLAN data transmission. Between usage times, the measuring device or rather the transceiver may, for example, be arranged in a charging station for charging a battery of the measuring device or rather the transceiver. The charging station may optionally be connected, for example via a wired or wireless data connection, to the control apparatus or to a further measuring device. In this way, corresponding documentation can take place. Moreover, the measured values received from the measuring device can be used for the control, for example, of a production line for the object, for example an extrusion line having an extrusion device. The measured values may also be used, for example, to check or even correct measured values of a stationary terahertz measuring device for determining geometric parameters of the object, in particular with a view to expected shrinkage or, alternatively, expected sagging of the object.

The evaluation apparatus may be an evaluation apparatus that is specially assigned to the measuring device. However, it is also possible for the evaluation apparatus to be a central evaluation apparatus which performs further tasks, for example actuation of an extrusion device based on the measurement results and/or said central evaluation apparatus is assigned to a further measuring apparatus and archives the measurement results of the measuring device and/or the measurement results of the further measuring apparatus and/or corrects values for shrinkage and/or sagging of the object based on the measurement results of the measuring device and/or the measurement results of the further measuring device, for example for control of an extrusion device.

In principle, the measuring device according to the invention may comprise all functions required for detecting objects and representing the result in the form of visible or audible signaling, or alternatively to detect objects, dimensions, etc., and display the results on a display. The evaluation apparatus is not strictly required, but it can advantageously be used, for example, to register, document, or use measured values or to optimize a process, e.g. in the manufacture of pipes or plates.

The invention also relates to a system comprising a measuring device according to the invention as well as the object. An embodiment of the system may further comprise a conveying apparatus for conveying the object in a longitudinal direction through a measuring region of the measuring device. The system according to the invention may also comprise a manufacturing apparatus, for example an extrusion device, for manufacturing the object.

The invention further encompasses a method for measuring a geometric parameter, in particular an inner and/or outer diameter and/or a wall thickness of a flat or strand-shaped, in particular tubular, object using a measuring device according to the invention or using a system according to the invention. As already explained, according to the invention, the measured values may be recorded at different positions on a production line for the object, for example, said production line being an extrusion line, for example. According to the invention, aside from regions in which the object has already attained its final geometry, i.e. in particular fully cooled or rather solidified, for example after or immediately before an object manufactured in an extrusion device has been cut to length, it is also possible to measure in the warm zone of the production line in particular, i.e. when the object still has flowable components and shrinkage and/or sagging is not yet complete. This has been explained above. On account of the portable design of the measuring device with the above-mentioned possible embodiments, a reliable measurement with quickly available results is also possible when the refractive index is not presumed to be known.

### BRIEF DESCRIPTION OF THE DRAWINGS

Exemplary embodiments of the invention are explained below in greater detail with reference to schematic figures, in which:

FIG. 1 schematically shows a first view of an embodiment of a measuring device according to the invention.

FIG. 2 schematically shows the embodiment of the measuring device from FIG. 1 in a view that has been rotated by 90° with respect to that of FIG. 1.

FIG. 3 schematically shows a first view of another embodiment of the measuring device according to the invention.

FIG. 4 schematically shows the embodiment of the measuring device from FIG. 3 in a view that has been rotated by 90° with respect to FIG. 3.

FIG. 5 schematically shows another embodiment of the measuring device in a view corresponding to the view of FIG. 4.

FIG. 6 schematically shows another embodiment of the measuring device in a view corresponding to that of FIG. 5.

The same reference signs refer to the same objects in the figures unless indicated otherwise.

### DETAILED DESCRIPTION OF THE INVENTION

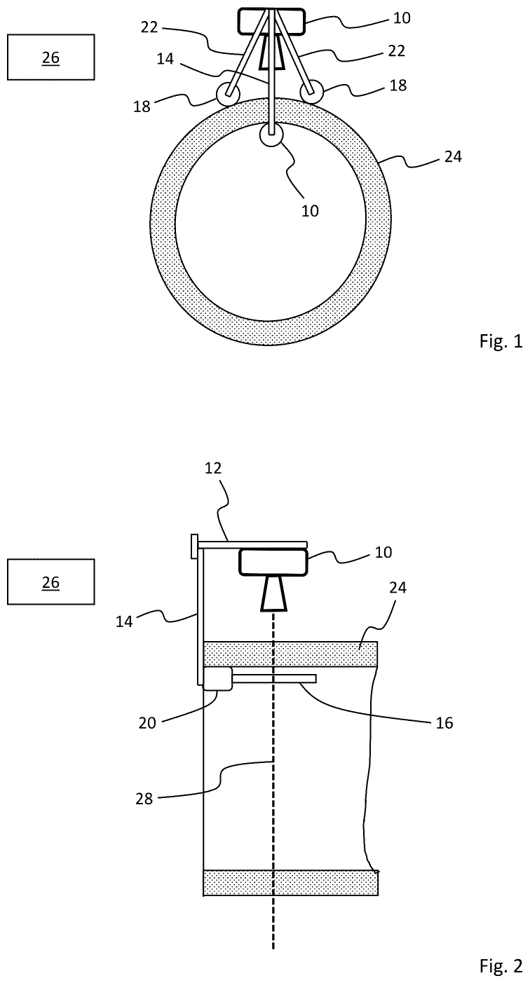

The measuring device according to the invention shown in FIGS. 1 and 2 comprises a transceiver 10 having a transmission apparatus for emitting terahertz radiation and having a receiving apparatus for receiving the terahertz radiation emitted by the transmission apparatus. In the example shown, the transceiver 10 is arranged on a leg 12 of a C-shaped holder 14, on the free end of which opposite the leg 12 a reflector 16 is arranged, which reflector is preferably partially transparent to the terahertz radiation emitted by the transmission apparatus, such that it reflects some of the terahertz radiation back to the transceiver 10 and thus to the receiving apparatus and allows some of the terahertz radiation to pass through. The holder 14 further comprises two outer guide rollers 18 and an inner guide roller 20. FIG. 2 does not show the outer guide rollers 18. The outer guide rollers 18 are in each case arranged at an outer end of a holding arm 22. The holding arms 22 form a V-shape and can be pressed apart by means of the guide rollers 18 against a preload provided, for example, by a preload spring. As shown in FIGS. 1 and 2, the measuring device may, for example, be placed against a tubular object 24, in particular a plastics pipe, such that the outer guide rollers 18 rest on the outer face of the plastics pipe and the inner guide roller 20 rests on the inner face of the plastics pipe. Due to the possibility of pressing the guide rollers 18 apart, same can be adapted to different pipe dimensions. Furthermore, as is visible in FIG. 2 in particular, the holder 14 forms a stop which can be placed against an end face of the tubular object 24 for placement of the measuring device. The transceiver 10 may be mounted on the holder 14, in particular the leg 12, in a longitudinally displaceable manner, in particular in the longitudinal direction of the tubular object 24, i.e. in the horizontal direction in FIG. 2. The reflector 16 may also be mounted on the holder 14 in a longitudinally displaceable manner, if desired. In this way, a defined orientation and position of the measuring device, in particular of the transceiver 10 and the reflector 16, relative to the tubular object 24 to be measured is ensured. The measuring device further comprises an evaluation apparatus 26, which may be connected to the transceiver 10 via a wireless data connection, for example.

During operation, the transmission apparatus of the transceiver 10 emits terahertz radiation onto the tubular object 24 to be measured, i.e. vertically downward in FIGS. 1 and 2, as illustrated in FIG. 2 by the dashed line 28. The terahertz radiation is reflected on boundary surfaces of the tubular object 24, in particular the outer and inner faces of the wall portions, as well as completely or partially on the reflector 16. After being reflected, the terahertz radiation returns to the transceiver 10 and is detected as a measurement signal by the receiving apparatus. The evaluation apparatus 26, which obtains the measured values, can use the delay time measurements, for example, to determine the optical thickness of the wall portions of the tubular object 24 and thus the outer and inner diameter of the tubular object 24. In order to determine herefrom the geometric values of the corresponding geometric parameters, the refractive index of the material of the tubular object 24 must be taken into account. For this purpose, the evaluation apparatus 26 can determine the refractive index of the tubular object 24 from the comparison of the delay time of the terahertz radiation emitted by the transmission apparatus and received by the receiving apparatus with said radiation passing through the tubular object 24 with the delay time of the terahertz radiation emitted by the transmission apparatus and received by the receiving apparatus without said radiation passing through the tubular object 24, in each case using the terahertz radiation reflected by the reflector 16. Since the measuring device shown in FIGS. 1 and 2 is configured such that the reflector 16 is arranged inside the tubular object 24, a measurement is accordingly possible from an end face of the tubular object 24, in particular after the tubular object 24 has been cut to length after being manufactured in an extrusion line, for example.

As explained, the evaluation apparatus 26 may be integrated in the transceiver 10. A power supply for charging a battery, for example, may be separate from the transceiver, for example. As also explained, the reflector 16 does not have to be partially transparent.

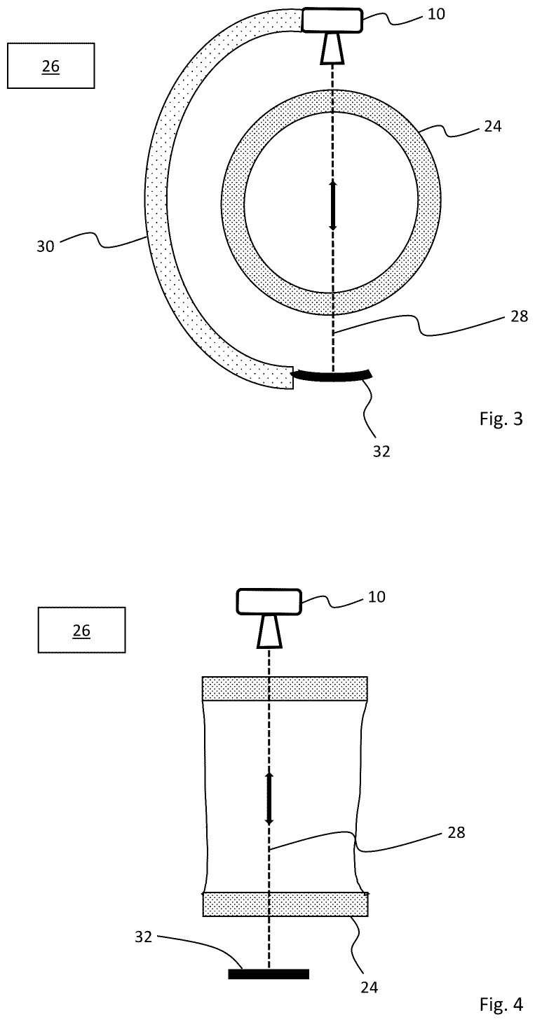

FIGS. 3 and 4 show a further exemplary embodiment of a measuring device according to the invention, by means of which a tubular object 24, in particular a plastics pipe, that has not yet been cut to length can, in particular, also be measured, in particular in the warm zone shortly after exiting an extrusion device or after exiting a first cooling tank, when the tubular object 24 thus still has flowable components. For this purpose, a curved holder 30 is provided, at one free end of which the transceiver 10 of the measuring device is arranged and at the other free end of which a reflector 32 is arranged, which reflector, in the example shown, has the shape of a cylindrical portion in adaptation to the geometry of the tubular object 24. The holder 30 may, for example, be comprised of a plastics material and be flexible. The holder allows for placement against the tubular object 24 from the outside, wherein the transceiver 10 and the reflector 32 are located on opposite outer faces of the tubular object 24. As illustrated again by the dashed line 28, terahertz radiation emitted by the transmission apparatus of the transceiver 10 is reflected on boundary surfaces of the tubular object 24 and on the reflector 32 arranged on the opposite side of the tubular object 24. The radiation components reflected in each case return to the receiving apparatus and are received thereby as measured values, which are in turn sent to the evaluation apparatus 26. The transceiver 10 may also comprise a display for representing the measured values. On this basis and in the manner explained above, the measuring device or rather the evaluation apparatus 26 can determine the refractive index of the material of the refractive index of the material of the plastics pipe and the wall thicknesses as well as the outer and inner diameters of the tubular object 24.

As explained, the evaluation apparatus 26 may be an evaluation apparatus 26 that is specially provided for the measuring device. However, it is also possible for the evaluation apparatus 26 to be a central evaluation apparatus which, for example, actuates an extrusion device and/or is assigned to a further measuring apparatus, as explained above.

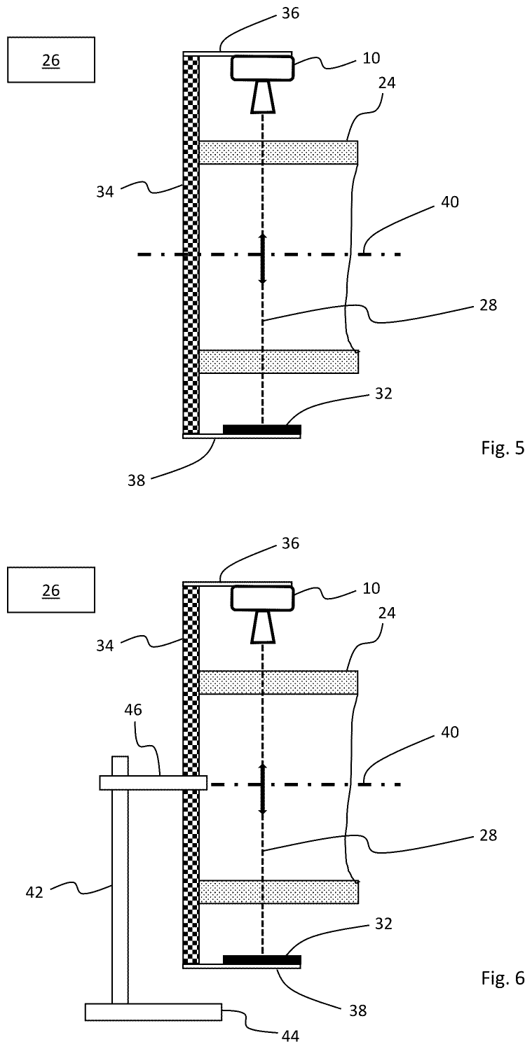

FIG. 5 shows a further exemplary embodiment of a measuring device according to the invention, which differs from the exemplary embodiment according to FIGS. 3 and 4 with regard to the holder 34. Said holder is configured similarly to the holder 14 in FIGS. 1 and 2 with two opposing legs 36, 38. The transceiver 10 is arranged on the leg 36 and the reflector 32 is arranged on the leg 38 and may have a curvature like the reflector 32 shown in FIGS. 3 and 4. In the exemplary embodiment shown in FIG. 5, the holder 34 may have guide rollers which are arranged on the legs 36, 38, abut opposing outer faces of the tubular object 24 in the state placed against the tubular object 24, and may be designed, for example, in the manner of the guide rollers 18 of the exemplary embodiment shown in FIGS. 1 and 2. Thus, a defined position and orientation of the measuring device, in particular of the transceiver 10 and reflector 32, with respect to the tubular object 24 is ensured, for example on the center axis 40 of the tubular object 24. Again, the holder 34 provides a stop for placement against the tubular object 24. Again, the transceiver 10 and/or the reflector 32 may be arranged on the holder 34, in particular the legs 36 and/or 38, respectively, so as to be longitudinally displaceable in the direction of the longitudinal axis of the tubular object.

The measuring device shown in FIG. 6 differs from the measuring device shown in FIG. 5 in that a holding portion 42 that is arranged in a stationary manner on, for example, an extrusion device for extruding the tubular object 24 is also provided. The holding portion 42 comprises a base plate 44, which is fastened, for example screwed, on the floor of a production area that houses the extrusion device, for example. The holder 34 may be arranged on the holding portion 42 via a cross-member 46. In this way, a positionally precise arrangement of the measuring device and secure guidance of the measuring device, for example during a rotation about the center axis 40, is ensured during the measurement.

Although the invention has been described based on exemplary embodiments for a tubular object 24, in particular a plastics pipe, it should be understood that it may also be used in a corresponding manner for other objects, for example flat objects or solid cylindrical objects. It is also possible that, instead of the narrow, rod-shaped reflector 16 shown in FIGS. 1 and 2, a reflector that is adapted to the pipe geometry with, for example, the shape of a cylindrical portion is used. Accordingly, a differently shaped reflector 32 would also be possible in the exemplary embodiments according to FIGS. 3 to 5.

In all exemplary embodiments, it is also possible for the transceiver 10 and/or the reflector 16, 32 to be detachably arranged on the holder 14, 30, or, alternatively, 34. This allows either for a measurement without a reflector or for removal of the transceiver 10, for example in order to charge a battery or for data transmission. For example, by removing the reflector 16 in the exemplary embodiment according to FIGS. 1 and 2, a measurement in the region of the plastics pipe that has not yet been cut to length or, alternatively, on a planar object would be possible if the refractive index of the material of the plastics pipe were known. The holding portion shown in FIG. 6 may also be provided in the exemplary embodiments according to FIGS. 1 to 4.

### LIST OF REFERENCE SIGNS

10 Transceiver
12 Leg
14 Holder
16 Reflector
18 Outer guide rollers
20 Inner guide roller
22 Holding arms
24 Tubular object
26 Evaluation apparatus
28 Line
30 Holder
32 Reflector
34 Holder
36 Leg
38 Leg
40 Center axis
42 Holding portion
44 Base plate
46 Cross-member

1. A measuring device for measuring a geometric parameter of an object, comprising:
a transceiver comprising a transmission apparatus configured to emit terahertz radiation onto the object, wherein the terahertz radiation is at least partially reflected by the object;
a receiving apparatus configured to receive the terahertz radiation emitted by the transmission apparatus onto the object;
a reflector configured to reflect the terahertz radiation emitted by the transmission apparatus after the terahertz radiation has passed through at least one portion of the object; and
a holder configured to support the transceiver and the reflector, and to position the transceiver and the reflector opposite one another on different sides of the object or on different sides of a wall of the object.

2. The measuring device according to claim 1, wherein the holder is C-shaped.

3. The measuring device according to claim 1, wherein the holder forms a stop which can be placed against an end face of the object for placement of the measuring device.

4. The measuring device according to claim 1, wherein at least one of the transceiver and the reflector is mounted in a longitudinally displaceable manner on the holder.

5. The measuring device according to claim 1, wherein at least one of the transceiver and the reflector are detachably arranged on the holder.

6. The measuring device according claim 1, wherein the reflector is spaced apart from the wall of the object that is adjacent to the reflector, and wherein some of the terahertz radiation passes through the reflector.

7. The measuring device according to claim 1, wherein the holder comprises at least one support structured to enable at least one of the of the transceiver and the reflector to rest on a surface of the object when the measuring device is placed against the object.

8. The measuring device according to claim 7, wherein the at least one support comprises at least one guide roller that rests on the surface of the object when the measuring device is placed against the object.

9. The measuring device according to claim 7, wherein the at least one support is configured to adjust to accommodate different dimensions of the object.

10. The measuring device according to claim 9, wherein the at least one support comprises at least two support portions that are spaced apart from each other and configured to be pressed apart counter to a preload.

11. The measuring device according to claim 1, further comprising at least one sensor configured to aid in orienting the measuring device with the holder for a measurement process without contacting the object.

12. The measuring device according to claim 11, wherein the at least one sensor comprises at least one of (i) an optical sensor; (ii) an inertial sensor; and (iii) a position sensor.

13. The measuring device according to claim 1, wherein the reflector comprises a shape that is adapted to a geometry of the object.

14. The measuring device according to claim 1, wherein the reflector is partially transparent to the terahertz radiation emitted by the transmission apparatus.

15. The measuring device according to claim 1, further comprising a holding portion configured to be arranged in a stationary manner on a manufacturing apparatus for manufacturing the object, wherein at least one of the transceiver and the holder is configured to be fastened to the holding portion in a detachable manner.

16. The measuring device according to claim 1, further comprising an evaluation apparatus configured to determine the geometric parameter of the object based on the terahertz radiation received by the receiving apparatus.

17. The measuring device according to claim 16, wherein the geometric parameter comprises at least one of: (i) a wall thickness; (ii) an inner diameter; and (iii) an outer diameter.

18. The measuring device according to claim 16, wherein the evaluation apparatus is configured to determine a refractive index of the object from a comparison of a delay time of the terahertz radiation emitted by the transmission apparatus and received by the receiving apparatus, wherein said radiation passing through the object with the delay time of the terahertz radiation emitted by the transmission apparatus and received by the receiving apparatus without said radiation passing through the object.

19. The measuring device according claim 1, further comprising a wireless transmission apparatus configured to at least one of:
transmit measured values received by the receiving apparatus to an evaluation apparatus that is separate from the measuring device; and
transmit data evaluated by the evaluation apparatus integrated in the measuring device to a control apparatus that is separate from the measuring device.

20. A system, comprising:
the measuring device according to claim 1; and
the object.

21. The system according to claim 20, further comprising a conveying apparatus configured to convey the object in a longitudinal direction through a measuring region of the measuring device.

22. A method of measuring a geometric parameter of an object, comprising:
positioning a transceiver and a reflector opposite one another on different sides of the object or on different sides of a wall of the object, wherein the transceiver comprises a transmission apparatus;
emitting terahertz radiation onto the object, wherein the terahertz radiation is at least partially reflected by the object;
receiving the terahertz radiation emitted by a transmission apparatus onto the object; and
reflecting the terahertz radiation emitted by the transmission apparatus after the terahertz radiation has passed through at least one portion of the object.
